(19) United States
(12) Patent Application Publication
(10) Pub. No.: US 2020/0009769 A1
(43) Pub. Date: Jan. 9, 2020

(54) METHOD FOR PRODUCING A 3D PRINTED, FOAM-FILED OBJECT

(71) Applicant: Covestro Deutschland AG, Leverkusen (DE)

(72) Inventors: Dirk ACHTEN, Leverkusen (DE); Thomas BÜSGEN, Leverkusen (DE); Nicolas DEGIORGIO, Krefeld (DE); Levent AKBAS, Witten (DE); Bettina MEIER, Dormagen (DE); Christoph TOMCZYK, Leverkusen (DE); Roland WAGNER, Leverkusen (DE); Rolf ALBACH, Köln (DE)

(21) Appl. No.: 16/468,170

(22) PCT Filed: Dec. 11, 2017
(86) PCT No.: PCT/EP2017/082154

§ 371 Date: Jun. 10, 2019

(30) Foreign Application Priority Data
Dec. 14, 2016 (EP) 16203988.7

(51) Int. Cl. B29C 44/08; B29C 44/18

(52) U.S. Cl. CPC B29C 44/08; B29C 64/106; B29C 44/18

(57) ABSTRACT

The invention relates to a method for producing an object comprising the the following steps: producing a shell, which surrounds a volume for holding a fluid, by means of an additive manufacturing method from a construction material; providing a reaction mixture comprising a polyisocyanate component and a polyol component in the volume and allowing the reaction mixture to react in the volume such that a polymer present at least partly in the volume is obtained. The reaction mixture has a setting time of ≥2 minutes. An object that can be obtained by means of a method according to the invention comprises a shell, which defines a volume located within the shell, and a foam, which completely or partly fills the volume. The shell comprises a thermoplastic polyurethane polymer, the foam comprises a polyurethane foam having a compressive strength at 10% compression (DIN EN 826) of ≥50 kPa or a compression hardness at 40% compression (ISO 3386) of ≤15 kPa and the foam and the shell are at least partly integrally bonded to each other. The object can be a football, for example.

The present invention relates to a method of producing an article, comprising the steps of: producing a shell encompassing a volume for accommodating a fluid by means of an additive manufacturing method from a construction material; providing a reaction mixture comprising a polyisocyanate component and a polyol component in the volume and allowing the reaction mixture to react in the volume to obtain a polymer present at least in part in the volume. The invention further relates to an article obtainable by a method of the invention, comprising a shell that defines a volume present within the shell, and a foam that wholly or partly fills the volume. The shell may subsequently be wholly or partly removed in order to obtain foam bodies of complex shape.

Additive manufacturing methods refer to those methods by which articles are built up layer by layer. They therefore differ markedly from other processes for producing articles such as milling, drilling or material removal. In the latter methods, an article is processed such that it takes on its final geometry via removal of material.

Additive manufacturing methods use different materials and processing techniques to build up articles layer by layer. In fused deposition modeling (FDM), for example, a thermoplastic wire is liquefied and deposited onto a movable construction platform layer by layer with the aid of a nozzle. Solidification gives rise to a solid article. The nozzle and construction platform are controlled on the basis of a CAD drawing of the article. If the geometry of this article is complex, for example with geometric undercuts, support materials additionally have to be printed and removed again after completion of the article.

In addition, there exist additive manufacturing methods that use thermoplastic powders to build up articles layer by layer. In this case, by means of what is called a coater, thin layers of powder are applied and then selectively melted by means of an energy source. The surrounding powder supports the component geometry. Complex geometries can thus be manufactured more economically than in the above-described FDM method. Moreover, different articles can be arranged or manufactured in a tightly packed manner in what is called the powder bed. Owing to these advantages, powder-based additive manufacturing methods are among the most economically viable additive manufacturing methods on the market. They are therefore used predominantly by industrial users. Examples of powder-based additive manufacturing methods are what are called selective laser sintering (SLS) or high-speed sintering (HSS). They differ from one another in the method for introducing energy for the selective melting into the plastic. In the laser sintering method, the energy is introduced via a deflected laser beam. In what is called the high-speed sintering (HSS) method (EP 1648686), the energy is introduced via infrared (IR) sources in combination with an IR absorber selectively printed into the powder bed. What is called selective heat sintering (SHS) utilizes the printing unit of a conventional thermal printer in order to selectively melt thermoplastic powders.

A further group of additive manufacturing methods uses free-radically crosslinkable resins which, if appropriate, take on their final strength in the article formed via a second curing mechanism. Examples of such methods are stereolithography methods and the DLP methods derived therefrom.

In the technical field of coatings, “dual-cure” systems are known, in which the coating material applied in liquid form is first crosslinked by free-radical, for example photochemical, means and then cure further via reactions of NCO groups with suitable co-reactants.

The presence of foam or other fillings between 3D-printed walls is known, for example, from patent applications WO 2015/065936 A2, WO 2015/139095 A1, WO 2016/086268 A1, WO 2016/124432 A1 or US 2016/059485 A1. For instance, WO 2015/139095 A1 discloses a method of producing a composite object with a computer-controlled apparatus and an apparatus of this kind. The apparatus comprises a reservoir containing a liquid, curable first material, means of selective solidification of the first material, and means of selective deposition of a second material. The process comprises the steps of selectively depositing portions of the second material and of selectively solidifying sections of the first material, such that the solidified sections of the first material and the deposited portions of the second material form the composite object.

WO 2016/086268 A1 describes a method of producing a buoyancy module for an undersea buoyancy system, comprising steps of: forming a shell, at least in part, by an additive manufacturing method; introducing a buoyancy material into the shell and sealing the shell.

The introducing of foam-forming reaction mixtures into cavities as known in the production of PUR or PUR/PIR foam bodies cannot be applied directly to 3D-printed shells. Reaction mixtures for “foam in place” methods or “reaction injection molding” methods are designed for high reaction rates and correspondingly short demolding times. However, the pressures that occur here as a result of the ascending foam and the blowing agent released can easily exceed the mechanical durability of 3D-printed shells.

It is an object of the present invention to at least partly overcome at least one disadvantage of the prior art. In addition, it is an object of the invention to provide an additive manufacturing method in which the articles to be produced can be obtained in a very cost-efficient and/or individualized and/or resource-conserving manner, which relates more particularly to the reutilizability of construction material.

The object is achieved in accordance with the invention by a method as claimed in claim 1 and an article as claimed in claim 13. Advantageous developments are specified in the subsidiary claims. They may be combined as desired, unless the opposite is apparent from the context.

A method of producing an article comprises the steps of:
producing a shell encompassing a volume for accommodating a fluid by means of an additive manufacturing method from a construction material;
providing a reaction mixture comprising a polyisocyanate component and a polyol component in the volume;
allowing the reaction mixture to react in the volume to obtain a polymer present at least in part in the volume.

In the process, the reaction mixture has a setting time of ≥2 minutes.

The method of the invention can produce articles having an outer shape limited only by the performance of the additive manufacturing method chosen and the equipment used. The articles are mechanically reinforced by the polymer obtained by reaction. It is thus also possible to reduce the manufacturing times for the articles since only the outer shell has to be manufactured.

Moreover, the process of the invention can produce a foam article of complex shape with internal foam geometries that is not obtainable by conventional methods. In this process, the shaping construction material manufactured by an additive method can preferably be removed again at least in part, for example by melting, thermolysis or hydrolysis.

The setting time is preferably ≥3 minutes, more preferably ≥5 minutes. It is further preferable that the setting time is ≥3 minutes to ≤90 minutes or ≥5 minutes to ≤60 minutes.

The setting time is that time after which a theoretically infinitely extended polymer has formed in the polyaddition between NCO-reactive components and polyisocyanate components. The setting time can be ascertained experimentally by dipping a thin wooden rod into the foaming reaction mixture at short intervals. The time from the mixing of the components until the time at which threads remain hanging off the rod when removed is the setting time.

Reaction mixtures with the setting times of the invention, which are regarded as slow in the specialist field, permit no damage to the shell by the unwanted side effects of the exothermic reaction of the reaction mixture to form a PUR or PUR/PIR material, or avoidance of unwanted highly inhomogeneous formation of the foam structure in the case of complex geometries. An unwanted effect is, for example, the melting or softening of a thermoplastic shell with loss of the envisaged shape. A slower reaction allows the heat of reaction released to be better removed. In the case of closed shells, in addition, pressure buildup in the interior of the shell by the reaction is undesirable, especially in combination with melting or softening of thermoplastic shell material. The slower the reaction proceeds, the more gas can diffuse outward through the shell. It may likewise be desirable for the method of the invention that the additively manufactured shell is not entirely gas-tight and/or liquid-tight.

The inventive setting time envisaged can be achieved by various measures individually or in combination. For instance, the reaction mixture may comprise an amine catalyst. Another measure is the use of slow-reacting aliphatic isocyanates. Finally, the polyol component may contain bifunctional polyols that lower the crosslinking density in the end product and also in the reacting reaction mixture, and hence may also have a prolonging effect on the setting time.

For simplification of the provision of the reaction mixture, it may be adjusted to a low viscosity. For example, the reaction mixture may have an initial viscosity (20° C., ASTM D 2393), i.e. immediately after the mixing of polyol component and isocyanate component, of ≥100 mPas to ≤5000 mPas.

The volume may, for example, be ≥1 cm³ to ≤5000 cm³.

After the provision of the reaction mixture in the volume, the shell along with the reaction mixture present can be rotated or pivoted in the space, such that the reaction mixture can be distributed homogeneously within the shell available.

There are conceivable cases in which the reaction mixture does not contain any blowing agent and hence does not cure to form a foam. In that case, the polymer obtained would act like a solid layer on the inside of the shell as mechanical reinforcement thereof. However, the advantages of the method of the invention are particularly manifested when the reaction mixture also contains a blowing agent. These may be physical and/or chemical blowing agents.

The construction material preferably comprises a polyurethane polymer. In that case, components of the reaction mixture can react with reactive groups still available in the polyurethane polymer present in the shell to form a cohesive bond. Particular preference is given to thermoplastic polyurethanes (TPUs), especially thermoplastic polyurethane elastomers (TPEs).

Suitable species for preparation of the polyurethane polymer in the construction material are the organic aliphatic, cycloaliphatic, araliphatic and/or aromatic polyisocyanates having at least two isocyanate groups per molecule that are known per se to those skilled in the art, and mixtures thereof. For example, it is possible to use NCO-terminated prepolymers.

NCO-reactive compounds having Zerewitinoff-active hydrogen atoms that can be used for preparation of the polyurethane polymer in the construction material may be any compounds known to those skilled in the art that have an average OH or NH functionality of at least 1.5. These may, for example, be low molecular weight diols (e.g. ethane-1,2-diol, propane-1,3- or -1,2-diol, butane-1,4-diol, pentane-1,5-diol, hexane-1,6-diol), triols (e.g. glycerol, trimethylolpropane) and tetraols (e.g. pentaerythritol), short-chain amino alcohols, polyamines, but also higher molecular weight polyhydroxyl compounds such as polyether polyols, polyester polyols, polycarbonate polyols, polyether carbonate diols, polysiloxane polyols, polyamines and polyether polyamines, and polybutadiene polyols.

The NCO groups in the polyurethane polymer of the construction material may be partly blocked. In that case, the process of the invention further includes the step of deblocking these NCO groups. After they have been deblocked, they are thus available for reactions with the reaction mixture to form a cohesive bond.

The blocking agent is chosen such that the NCO groups are at least partly deblocked on heating. Examples of blocking agents are alcohols, lactams, oximes, malonic esters, alkyl acetoacetates, triazoles, phenols, imidazoles, pyrazoles and amines, for example butanone oxime, diisopropylamine, 1,2,4-triazole, dimethyl-1,2,4-triazole, imidazole, diethyl malonate, ethyl acetoacetate, acetone oxime, 3,5-dimethylpyrazole, ε-caprolactam, N-methyl-, N-ethyl-, N-(iso)propyl-, N-n-butyl-, N-isobutyl-, N-tert-butylbenzylamine or 1,1-dimethylbenzylamine, N-alkyl-N-1,1-dimethylmethylphenylamine, adducts of benzylamine onto compounds having activated double bonds such as malonic esters, N,N-dimethylaminopropylbenzylamine and other optionally substituted benzylamines containing tertiary amino groups and or dibenzylamine, or any desired mixtures of these blocking agents.

In a preferred embodiment, the construction material is free-radically crosslinkable and comprises groups having Zerewitinoff-active hydrogen atoms, the shell is obtained from a precursor and the method comprises the steps of:
I) depositing free-radically crosslinked construction material on a carrier to obtain a ply of a construction material bonded to the carrier which corresponds to a first selected cross section of the precursor,
II) depositing free-radically crosslinked construction material onto a previously applied ply of the construction material to obtain a further ply of the construction material which corresponds to a further selected cross section of the precursor and which is bonded to the previously applied ply;
III) repeating step II) until the precursor is formed;

wherein the depositing of free-radically crosslinked construction material at least in step II) is effected by exposure and/or irradiation of a selected region of a free-radically crosslinkable construction material corresponding to the respectively selected cross section of the precursor, and

wherein the free-radically crosslinkable construction material has a viscosity (23° C., DIN EN ISO 2884-1) of ≥5 mPas to ≤100 000 mPas,

wherein the free-radically crosslinkable construction material comprises a curable component in which there are NCO groups and olefinic C═C double bonds,

and step III) is followed by a further step IV):
IV) heating the precursor obtained by step III) to a temperature of ≥50° C. to obtain the shell.

In this variant, the shell is thus obtained in two production phases. The first production phase can be regarded as the construction phase. This construction phase can be implemented by means of additive manufacturing methods via particle optics, such as the inkjet method, stereolithography or the DLP (digital light processing) method and is represented by steps I), II) and III). The second production phase can be regarded as the curing phase and is represented by step IV). The precursor or intermediate shell obtained after the construction phase is converted here to a mechanically more durable shell without any further change in shape.

Step I) of this variant of the method comprises depositing a free-radically crosslinked construction material on a carrier. This is usually the first step in inkjet, stereolithography and DLP methods. In this way a ply of a construction material bonded to the carrier which corresponds to a first selected cross section of the precursor is obtained.

As per the instruction of step III), step II) is repeated until the desired precursor has been formed. Step II) comprises depositing a free-radically crosslinked construction material on a previously applied ply of the construction material to obtain a further ply of the construction material which corresponds to a further selected cross section of the precursor and which is bonded to the previously applied ply. The previously applied ply of the construction material may be the first ply from step I) or a ply from a previous run of step II).

In this process variant, a free-radically crosslinked construction material at least in step II) (preferably also in step 1) is deposited by exposure and/or irradiation of a selected region of a free-radically crosslinkable resin corresponding to the respectively selected cross section of the precursor. This can be achieved either by selective exposure (stereolithography, DLP) of the crosslinkable construction material or by selective application of the crosslinkable construction material, followed by an exposure step which, on account of the preceding selective application of the crosslinkable construction material, need no longer be selective (inkjet method).

In the context of this process variant, the terms “free-radically crosslinkable construction material” and “free-radically crosslinked construction material” are used. The free-radically crosslinkable construction material is converted here to the free-radically crosslinked construction material by the exposure and/or irradiation which triggers free-radical crosslinking reactions. In this context, “exposure” is understood to mean introduction of light in the range between near-IR and near-UV light (wavelengths of 1400 nm to 315 nm). The remaining shorter wavelength ranges are covered by the term “irradiation”, for example far-UV light, x-radiation, gamma radiation and also electron beams.

The respective cross section is appropriately chosen by a CAD program with which a model of the shell to be produced has been created. This operation is also known as “slicing” and serves as a basis for controlling the exposure and/or irradiation of the free-radically crosslinkable resin.

In this process variant, the free-radically crosslinkable construction material has a viscosity (23° C., DIN EN ISO 2884-1) of ≥5 mPas to ≤100 000 mPas. It should thus be regarded as a liquid resin at least for the purposes of additive manufacturing. The viscosity is preferably ≥50 mPas to ≤10 000 mPas, more preferably ≥500 mPas to ≤5000 mPas.

In addition, in the method, the free-radically crosslinkable resin has a curable component in which there are NCO groups and olefinic C═C double bonds. In this curable component, the molar ratio of NCO groups to olefinic C═C double bonds may be within a range from ≥1:5 to ≤5:1 (preferably ≥1:4 to ≤4:1, more preferably ≥1:3 to ≤3:1). The molecular ratio of these functional groups can be determined by the integration of the signals of a sample in the ¹³C NMR spectrum.

In addition to the curable component the free-radically crosslinkable construction material may also comprise a non-curable component in which for example stabilizers, fillers and the like are combined. In the curable component, the NCO groups and the olefinic C═C double bonds may be present in separate molecules and/or in a common molecule. When NCO groups and olefinic C═C double bonds are present in separate molecules, the body obtained after step IV) of this method variant has an interpenetrating polymer network.

In this variant of the method, in addition, step IV) is also conducted after step III). In this step, the precursor obtained after step III) is heated to a temperature of ≥50° C., preferably ≥65° C., more preferably ≥80° C., especially preferably ≥80° C. to ≤200° C., to obtain the shell. The heating can be effected for a period of time of ≥1 minute, preferably ≥5 minutes, more preferably ≥10 minutes to ≤24 hours, preferably ≤8 hours, more preferably <4 hours.

The reaction is preferably conducted until ≤20%, preferably ≤10% and more preferably ≤5% of the NCO groups originally present are still present. This can be determined by quantitative IR spectroscopy.

It is preferable that step IV) is not conducted until the entirety of the construction material of the precursor has reached its gel point. The gel point is considered to have been reached when, in a dynamic-mechanical analysis (DMA) with a plate/plate oscillation viscometer in accordance with ISO 6721-10 at 20° C., the graphs of the storage modulus G′ and the loss modulus G″ intersect. The precursor is optionally subjected to further exposure and/or radiation to complete free-radical crosslinking. The free-radically crosslinked construction material may have a storage modulus G′ (DMA, plate/plate oscillation viscometer according to ISO 6721-10 at 20° C. and a shear rate of I/s) of ≥106 Pa.

The free-radically crosslinkable construction material may further comprise additives such as fillers, UV-stabilizers, free-radical inhibitors, antioxidants, mold release agents, water scavengers, slip additives, defoamers, flow agents, rheology additives, flame retardants and/or pigments. These auxiliaries and additives, excluding fillers and flame retardants, are typically present in an amount of less than 10% by weight, preferably less than 5% by weight, more preferably up to 3% by weight, based on the free-radically crosslinkable resin. Flame retardants are typically present in amounts of not more than 70% by weight, preferably not more than 50% by weight, more preferably not more than 30% by weight, calculated as the total amount of flame retardants used based on the total weight of the free-radically crosslinkable construction material.

Suitable fillers are, for example, AlOH₃, CaCO₃, metal pigments such as TiO₂ and further known customary fillers. These tillers are preferably used in amounts of not more than 70% by weight, preferably not more than 50% by weight, more preferably not more than 30% by weight, calculated as the total amount of fillers used based on the total weight of the free-radically crosslinkable resin.

Suitable UV stabilizers may preferably be selected from the group consisting of piperidine derivatives, for example 4-benzoyloxy-2,2,6,6-tetramethylpiperidine, 4-benzoyloxy-1,2,2,6,6-pentamethylpiperidine, bis(2,2,6,6-tetramethyl-4-piperidyl) sebacate, bis(1,2,2,6,6-pentamethyl-1-4-piperidinyl) sebacate, bis(2,2,6,6-tetramethyl-4-piperidyl) suberate, bis(2,2,6,6-tetramethyl-4-piperidyl) dodecanedioate; benzophenone derivatives, for example 2,4-dihydroxy-, 2-hydroxy-4-methoxy-, 2-hydroxy-4-octoxy-, 2-hydroxy-4-dodecyloxy- or −2,2′-dihydroxy-4-dodecyloxybenzophenone; benzotriazole derivatives, for example 2-(2H-benzotriazol-2-yl)-4,6-di-tert-pentylphenol, 2-(2H-benzotriazol-2-yl)-6-dodecyl-4-methylphenol, 2-(2H-benzotriazol-2-yl)-4,6-bis(1-methyl-1-phenylethyl)phenol, 2-(5-chloro-2H-benzotriazol-2-yl)-6-(1,1-dimethylethyl)-4-methylphenol, 2-(2H-benzotriazol-2-yl)-4-(1,1,3,3-tetramethylbutyl)phenol, 2-(2H-benzotriazol-2-yl)-6-(1 methyl-1-phenylethyl)-4-(1,1,3,3-tetramethylbutyl)phenol, isooctyl 3-(3-(2H-benzotriazol-2-yl)-5-(1,1-dimethylethyl)-4-hydroxyphenylpropionate), 2-(2H-benzotriazol-2-yl)-4,6-bis(1,1-dimethylethyl)phenol, 2-(2H-benzotriazol-2-yl)-4,6-bis(l-methyl-1-phenylethyl)phenol, 2-(5-chloro-2H-benzotriazol-2-yl)-4,6-bis(1,1-dimethylethyl)phenol; oxalanilides, for example 2-ethyl-2′-ethoxy- or 4-methyl-4′-methoxyoxalanilide, salicylic esters, for example phenyl salicylate, 4-tert-butylphenyl salicylate, 4-tert-octylphenyl salicylate; cinnamic ester derivatives, for example methyl α-cyano-β-methyl-4-methoxycinnamate, butyl α-cyano-β-methyl-4-methoxycinnamate, ethyl α-cyano-β-phenylcinnamate, isooctyl α-cyano-β-phenylcinnamate; and malonic ester derivatives, such as dimethyl 4-methoxybenzylidenemalonate, diethyl 4-methoxybenzylidenemalonate, dimethyl 4-butoxybenzylidenemalonate. These preferred light stabilizers may be used either individually or in any desired combinations with one another.

Particularly preferred UV stabilizers are those which completely absorb radiation having a wavelength <400 nm. These include the recited benzotriazole derivatives for example. Very particularly preferred UV stabilizers are 2-(5-chloro-2H-benzotriazol-2-yl)-6-(1,1-dimethylethyl)-4-methylphenol, 2-(2H-benzotriazol-2-yl)-4-(1,1,3,3-tetramethylbutyl)phenol and/or 2-(5-chloro-2H-benzotriazol-2-yl)-4,6-bis(1, -dimethylethyl)phenol.

One or more of the UV stabilizers recited by way of example are optionally added to the free-radically crosslinkable construction material preferably in amounts of 0.001 to 3.0% by weight, more preferably 0.005 to 2% by weight, calculated as the total amount of UV stabilizers used based on the total weight of the free-radically crosslinkable construction material.

Suitable antioxidants are preferably sterically hindered phenols which may be selected preferably from the group consisting of 2,6-di-tert-butyl-4-methylphenol (ionol), pentaerythritol tetrakis(3-(3,5-di-tert-butyl-4-hydroxyphenyl)propionate), octadecyl 3-(3,5-di-tert-butyl-4-hydroxyphenyl)propionate, triethylene glycol bis(3-tert-butyl-4-hydroxy-5-methylphenyl)propionate, 2,2′-thiobis(4-methyl-6-tert-butylphenol) and 2,2′-thiodiethyl bis[3-(3,5-di-tert-butyl-4-hydroxyphenyl)propionate]. These may be used either individually or in any desired combinations with one another as required. These antioxidants are preferably used in amounts of 0.01% to 3.0% by weight, more preferably 0.02% to 2.0% by weight, calculated as the total amount of antioxidants used based on the total weight of the free-radically crosslinkable construction material.

Suitable free-radical inhibitors/retarders are preferably those which specifically inhibit uncontrolled free-radical polymerization of the resin formulation outside the desired (irradiated) region. These are crucial for good contour sharpness and imaging accuracy in the precursor. Suitable free-radical inhibitors must be chosen according to the desired free-radical yield from the irradiation/exposure step and the polymerization rate and reactivity/selectivity of the double bond carrier. Suitable free-radical inhibitors are, for example, 2,2-(2,5-thiophenediyl)bis(5-tert-butylbenzoxazole), phenothiazine, hydroquinones, hydroquinone ether, quinone alkyds and nitroxyl compounds and mixtures thereof, benzoquinones, copper salts, catechols, cresols, nitrobenzene and oxygen. These antioxidants are preferably used in amounts of 0.001% by weight to 3% by weight. In a further preferred embodiment, the olefinic double bonds are present in the free-radically crosslinkable construction material at least partially in the form of (meth)acrylate groups.

In a further preferred embodiment, the free-radically crosslinkable construction material comprises a compound obtainable from the reaction of an NCO-terminated polyisocyanate prepolymer with a molar deficiency, based on the free NCO groups, of a hydroxyalkyl (meth)acrylate.

In a further preferred embodiment, the free-radically crosslinkable construction material comprises a compound obtainable from the reaction of an NCO-terminated polyisocyanurate with a molar deficiency, based on the free NCO groups, of a hydroxyalkyl (meth)acrylate.

Suitable polyisocyanates for preparation of the NCO-terminated polyisocyanurates and prepolymers are, for example, those having a molecular weight in the range from 140 to 400 g/mol, having aliphatically, cycloaliphatically, araliphatically and/or aromatically bonded isocyanate groups, for example 1,4-diisocyanatobutane (BDI), 1,5-diisocyanatopentane (PDI), 1,6-diisocyanatohexane (HDI), 2-methyl-1,5-diisocyanatopentane, 1,5-diisocyanato-2,2-dimethylpentane, 2,2,4- or 2,4,4-trimethyl-1,6-diisocyanatohexane, 10-diisocyanatodecane, 1,3- and 1,4-diisocyanatocyclohexane, 1,4-diisocyanato-3,3,5-trimethylcyclohexane, 1,3-diisocyanato-2-methylcyclohexane, 1,3-diisocyanato-4-methylcyclohexane, 1-isocyanato-3,3,5-trimethyl-5-isocyanatomethylcyclohexane (isophorone diisocyanate; IPDI), 1-isocyanato-1-methyl-4(3)-isocyanatomethylcyclohexane, 2,4′- and 4,4′-diisocyanatodicyclohexylmethane (H₁₂MDI), 1,3- and 1,4-bis(isocyanatomethyl)cyclohexane, bis(isocyanatomethyl)norbornane (NBDI), 4,4′-diisocyanato-3,3′-dimethyldicyclohexylmethane, 4,4′-diisocyanato-3,3′,5,5′-tetramethyldicyclohexylmethane, 4,4′-diisocyanato-1,1′-bi(cyclohexyl), 4,4′-diisocyanato-3,3′-dimethyl-1,1′-bi(cyclohexyl), 4,4′-diisocyanato-2,2′,5,5′-tetramethyl-1,1′-bi(cyclohexyl), 1,8-diisocyanato-p-menthane, 1,3-diisocyanatoadamantane, 1,3-dimethyl-5,7-diisocyanatoadamantane, 1,3- and 1,4-bis(isocyanatomethyl)benzene (xylylene diisocyanate; XDI), 1,3- and 1,4-bis(1-isocyanato-1-methylethyl)benzene (TMXDI) and bis(4-(1-isocyanato-1-methylethyl)phenyl) carbonate, 2,4- and 2,6-diisocyanatotoluene (TDI), 2,4′- and 4,4′-diisocyanatodiphenylmethane (MDI), 1,5-diisocyanatonaphthalene and any desired mixtures of such diisocyanates.

It is additionally possible in accordance with the invention also to use aliphatic and/or aromatic prepolymers bearing isocyanate end groups, for example aliphatic or aromatic polyether, polyester, polyacrylate, polyepoxide or polycarbonate prepolymers bearing isocyanate end groups, as reactants in the isocyanurate formation. Suitable trimerization catalysts are described hereinbelow in connection with another embodiment.

Suitable hydroxyalkyl (meth)acrylates include alkoxyalkyl (meth)acrylates having 2 to 12 carbon atoms in the hydroxyalkyl radical. Preference is given to 2-hydroxyethyl acrylate, the isomer mixture formed during addition of propylene oxide onto acrylic acid, or 4-hydroxybutyl acrylate.

The reaction between the hydroxyalkyl (meth)acrylate and the NCO-terminated polyisocyanurate may be catalyzed by the customary urethanization catalysts such as DBTL. In this reaction the molar ratio of NCO groups to OH groups of the hydroxyalkyl (meth)acrylate may be in a range from ≥10:1 to ≤1.1:1 (preferably ≥5:1 to ≤1.5:1, more preferably ≥4:1 to ≤2:1). The curable compound obtained may have a number-average molecular weight Mₙ of ≥200 g/mol to ≤5000 g/mol. This molecular weight is preferably ≥300 g/mol to ≤4000 g/mol, more preferably ≥400 g/mol to ≤3000 g/mol.

Particular preference is given to a curable compound obtained from the reaction of an NCO-terminated polyisocyanurate with hydroxyethyl (meth)acrylate, wherein the NCO-terminated polyisocyanurate has been obtained from hexamethylene 1,6-diisocyanate in the presence of an isocyanate trimerization catalyst. This curable compound has a number-average molecular weight Mₙ of ≥400 g/mol to ≤3000 g/mol and a molar ratio of NCO groups and olefinic C═C double bonds in a range from ≥1:5 to ≤5:1, more preferably ≥1:3 to ≤3:1, most preferably ≥1:2 to ≤2:1.

In a further preferred embodiment the free-radically crosslinkable resin further comprises a free-radical initiator and/or an isocyanate trimerization catalyst. To prevent an undesired increase in the viscosity of the free-radically crosslinkable resin, free-radical initiators and/or isocyanate trimerization catalyst may be added to the resin only immediately before commencement of the process according to the invention.

Useful free-radical initiators include thermal and/or photochemical free-radical initiators (photoinitiators). It is also possible to use thermal and photochemical free-radical initiators simultaneously. Suitable thermal free-radical initiators are, for example, azobisisobutyronitrile (AIBN), dibenzoyl peroxide (DBPO), di-tert-butyl peroxide and/or inorganic peroxides such as peroxodisulfates.

Photoinitiators are in principle distinguished into two types, the unimolecular type (I) and the bimolecular type (II). Suitable type (I) systems are aromatic ketone compounds, for example benzophenones in combination with tertiary amines, alkylbenzophenones, 4,4′-bis(dimethylamino)benzophenone (Michler's ketone), anthrone and halogenated benzophenones or mixtures of the recited types. Also suitable are type (II) initiators such as benzoin and derivatives thereof, benzil ketals, acylphosphine oxides, 2,4,6-trimethylbenzoyldiphenylphosphine oxide, bisacylphosphine oxides, phenylglyoxylic esters, camphorquinone, α-aminoalkylphenones, α,α-dialkoxyacetophenones and α-hydroxyalkylphenones. Specific examples are Irgacure® 500 (a mixture of benzophenone and 1-hydroxycyclohexyl phenyl ketone, from Ciba, Lampertheim, DE), Irgacure® 819 DW (phenylbis(2,4,6-trimethylbenzoyl)phosphine oxide, from Ciba. Lampertheim, DE) or Esacure® KIP EM (oligo-[2-hydroxy-2-methyl−1-[4-(1-methylvinyl)phenyl]propanones], from Lamberti, Aldizzate, Italy) and bis(4-methoxybenzoyl)diethylgermanium. It is also possible to use mixtures of these compounds.

It should be ensured that the photoinitiators have a sufficient reactivity toward the radiation source used. A multitude of photoinitiators is known on the market. Commercially available photoinitiators cover the wavelength range of the entire UV-VIS spectrum. Photoinitiators find use in the production of paints, printing inks and adhesives and also in the dental sector.

In this process variant, the photoinitiator is generally used in a concentration, based on the amount of the curable olefinically unsaturated component bearing double bonds used, of 0.01% to 6.0% by weight, preferably of 0.05% to 4.0% by weight and more preferably of 0.1% to 3.0% by weight.

In a further preferred embodiment, the method has the following features:
the carrier is disposed within a vessel and is lowerable vertically counter to the direction of gravity,
the vessel contains the free-radically crosslinkable construction material in an amount sufficient to cover at least the carrier and an uppermost surface of crosslinked construction material deposited on the carrier as viewed in vertical direction.
before each step II) the carrier is lowered by a predetermined distance so that a layer of the free-radically crosslinkable construction material is formed above the uppermost ply of the crosslinked construction material as viewed in vertical direction and
in step II) an energy beam exposes and/or irradiates the selected region of the layer of the free-radically crosslinkable construction material corresponding to the respectively selected cross section of the precursor.

Accordingly, this embodiment covers the additive manufacturing process of stereolithography (SLA). The carrier may for example be lowered by a predetermined distance of ≥1 μm to ≤2000 μm in each case.

In a further preferred embodiment, the method has the following features:
the carrier is disposed within a vessel and is liftable vertically counter to the direction of gravity,
the vessel provides the free-radically crosslinkable construction material,
before each step II) the carrier is lifted by a predetermined distance so that a layer of the free-radically crosslinkable construction material is formed below the lowermost ply of the crosslinked construction material as viewed in vertical direction and
in step II) a multitude of energy beams simultaneously exposes and/or irradiates the selected region of the layer of the free-radically crosslinkable construction material corresponding to the respectively selected cross section of the precursor.

Accordingly, this embodiment covers the additive manufacturing process of DLP technology when the plurality of energy beams generate the image to be provided by exposure and/or irradiation via an array of individually controllable micromirrors. The carrier may for example be raised by a predetermined distance of ≥1 μm to ≤2000 μm in each case.

In a further preferred embodiment, the method has the following features:
in step II) the free-radically crosslinkable construction material is applied from one or more print heads corresponding to the respectively selected cross section of the precursor and is subsequently exposed and/or irradiated.

Accordingly, this embodiment covers the additive manufacturing method of the inkjet method: the crosslinkable construction material, optionally separately from the catalysts of the invention, is applied selectively via one or more print heads and the subsequent curing by irradiation and/or exposure may be nonselective, for example via a UV lamp. The one or more print heads for application of the crosslinkable construction material may be (modified) print heads for inkjet printing processes. The carrier may be configured to be movable away from the print head or the print head may be configured to be movable away from the carrier. The increments of the spacing movements between the carrier and the print head may be in a range from ≥1 μm to ≤2000 μm for example.

In a further preferred embodiment, the production of the shell by means of the additive manufacturing method comprises the steps of:
applying a layer of particles including the construction material to a target surface;
introducing energy into a selected portion of the layer corresponding to a cross section of the shell to bond the particles in the selected portion;
repeating the steps of applying and introducing energy for a multitude of layers to bond the bonded portions of the adjacent layers to form the shell.

This embodiment involves a powder sintering or powder fusion method. It is preferable that at least 90% by weight of the particles have a particle diameter of ≤0.25 mm, preferably ≤0.2 mm, more preferably ≤0.15 mm. The energy source for bonding of the particles may be electromagnetic energy, for example UV to IR light. An electron beam is also conceivable. The bonding of the particles in the irradiated portion of the particle layer is typically effected through (partial) melting of a (semi-)crystalline material and bonding of the material in the course of cooling. Alternatively, it is possible that other transformations of the particles such as a glass transition, i.e. the heating of the material to a temperature above the glass transition temperature, bring about bonding of the particles to one another.

In a further preferred embodiment, the introducing of energy into a selected portion of the layer corresponding to a cross section of the shell such that the particles in the selected portion are bonded comprises the following step:
irradiating a selected portion of the layer corresponding to a cross section of the shell with an energy beam to bond the particles in the selected portion.

This form of the method can be regarded as a selective sintering method, especially as a selective laser sintering method (SLS). The beam of energy for bonding of the particles may be a beam of electromagnetic energy, for example a “light beam” of (UV to IR light. Preferably, the beam of energy is a laser beam, more preferably having a wavelength between 600 nm and 15 μm. The laser may take the form of a semiconductor laser or of a gas laser. An electron beam is also conceivable.

In a further preferred embodiment, the introducing of energy into a selected portion of the layer corresponding to a cross section of the shell such that the particles in the selected portion are bonded comprises the following steps:
applying a liquid to a selected portion of the layer corresponding to a cross section of the shell, where said liquid increases the absorption of energy in the regions of the layer with which it comes into contact relative to the regions with which it does not come into contact;
irradiating the layer such that the particles in regions of the layer that come into contact with the liquid are bonded to one another and the particles in regions of the layer that do not come into contact with the liquid are not bonded to one another.

In this embodiment, for example, a liquid comprising an IR absorber can be applied to the layer by means of inkjet methods. The irradiation of the layer leads to selective heating of those particles that are in contact with the liquid including the IR absorber. In this way, bonding of the particles can be achieved Optionally, it is additionally possible to use a second liquid complementary to the energy-absorbing liquid in terms of its characteristics with respect to the energy used. In regions in which the second liquid is applied, the energy used is not absorbed but reflected. The regions beneath the second liquid are thus shaded. In this way, the separation sharpness between regions of the layer that are to be melted and not to be melted can be increased.

In a further preferred embodiment, the production of the shell by means of the additive manufacturing method comprises the steps of:
applying a layer of particles including the construction material to a target surface;
applying a liquid to a selected portion of the layer corresponding to a cross section of the shell, where the liquid is selected in such a way that it bonds the particles to one another in the regions of the layer with which it comes into contact by bonding, fusion and/or partial dissolution;
repeating the steps of applying the layer and the liquid to bond the bonded portions of the adjacent layers to form the shell.

This form of the method can be regarded as a “binder jetting” method. The liquid can come into contact with the powder layer in a wide variety of different ways as described and consolidate it in a controlled manner.

Preferred construction materials that are processed in this way are either inorganic sands, for example SiO₂ or gypsum, or organic polymer powders such as polystyrene, polyvinyl chloride, polymethylmethacrylate and polyurethane.

In a further preferred embodiment, the production of the shell by means of the additive manufacturing method comprises the steps of:
applying a filament of an at least partly molten construction material to a carrier to obtain a ply of the construction material corresponding to a first selected cross section of the shell;
applying a filament of the at least partly molten construction material to a previously applied ply of the construction material to obtain a further ply of the construction material which corresponds to a further selected cross section of the shell and which is bonded to the ply applied beforehand;
repeating the step of applying a filament of the at least partly molten construction material to a previously applied ply of the construction material until the shell has been formed.

This embodiment is a melt coating or fused deposition modeling (FDM) method. The individual filaments which are applied may have a diameter of ≥30 μm to ≤2000 μm, preferably ≥40 μm to ≤1000 μm and more preferably ≥50 μm to ≤500 μm.

The first step of this embodiment of the process relates to the construction of the first layer on a carrier. Subsequently, the second step, in which further layers are applied to previously applied layers of the construction material, is executed until the desired end result in the form of the article is obtained. The at least partly molten construction material bonds to existing layers of the material in order to form a structure in z direction. But it is possible that just one layer of the construction material is applied to a carrier.

In a further preferred embodiment, the reaction mixture reacts to form a foam having a compressive strength at 10% compression (DIN EN 826) of ≥50 kPa, preferably ≥95 kPa to ≤800 kPa, or to form a foam having a compression hardness at 40% compression (ISO 3386-1) of ≤15 kPa, preferably ≤12 kPa, most preferably ≥1 kPa to ≤10 kPa.

The foams preferred in accordance with the invention have an apparent density (ISO 845) of ≤300 g/L, more preferably ≤200 g/L and more preferably ≤100 g/L.

In a further preferred embodiment, the polyol component comprises a bifunctional polyether polyol and/or a bifunctional polyester polyol and/or a bifunctional polyether carbonate polyol.

The bifunctional polyether polyol is preferably a polyoxyalkylene polyol having a hydroxyl number (DIN 53240) of ≥150 to ≤550 mg KOH/g. It may also be used, for example, in a proportion of ≥3% to ≤25% by weight, preferably ≥5% to ≤20% by weight, based on the total weight of the polyol component.

It is also preferable that the bifunctional polyester polyol has a hydroxyl number (DIN 53240) of ≥200 to ≤500 mg KOH/g.

One example of a reaction mixture usable in the method of the invention comprises the polyisocyanate component A) and/or polyol component B) detailed hereinafter, which are also described in patent application EP 2 784 100 A1.

Polyisocyanate component A) comprising:
A1) 0% to 10% by weight, preferably 0.1% to 8% by weight, more preferably 0.1-5% by weight, based on the organic polyisocyanate component A), of diphenylmethane 2,2′-diisocyanate,
A2) 0% to 30% by weight, preferably 10% to 25% by weight, based on the organic polyisocyanate component A), of diphenylmethane 2,4′-diisocyanate and
A3) 25% to 75% by weight, preferably 35% to 55% by weight, based on the polyisocyanate component A), of diphenylmethane 4,4′-diisocyanate

Polyol component B) comprising:
B1) 20% to 70% by weight, preferably 25% to 45% by weight, based on component B, of polyoxyalkylene polyols having a hydroxyl number of 25 to 60 mg KOH/g and a number-average functionality of 2 to 4,
B2) 20% to 50% by weight, based on component B, of polyoxypropylene polyols having a hydroxyl number of 300 to 900 mg KOH/g and a number-average functionality of 2.5 to 4,
B3) 0% to 25% by weight, preferably 5% to 20% by weight, based on component B, of polyoxyalkylene polyols having a hydroxyl number of 150 to 550 mg KOH/g and a functionality of 2,
B4) 0% to 20% by weight, based on component B, of polyols containing ester groups and having a hydroxyl number of 200 to 500 mg KOH/g and a number-average functionality of 2 to 5,
B5) 0.1% to 15% by weight, preferably 0.1% to 5% by weight, based on component B, of propylene oxide-ethylene oxide copolymers having a hydroxyl number of 25 to 200 mg KOH/g and a functionality of 5 to 8, preferably 6,
B6) 0% to 3% by weight, based on component B, of glycerol,
B7) 1% to 7% by weight, preferably 4% to 6.5% by weight, more preferably 5.6% to 6.6% by weight, based on component B, of water,
B8) 0.5% to 4% by weight, based on component B, of catalysts,
B9) optionally auxiliaries and/or additives,

where the NCO index (ratio of number of NCO groups to the number of NCO-reactive groups multiplied by 100) is 85 to 125, preferably 100 to 120, and the sum total of components B1) to B9) is 100% by weight.

Polyisocyanate components used are preferably mixtures of diphenylmethane 4,4′-, 2,4′- and 2,2′-diisocyanates and polyphenyl polymethylene polyisocyanates (crude MDI). Crude MDI grades having a diphenylmethane diisocyanate isomer content of 50% to 70% by weight have been found to be particularly useful.

As component B1) preference is given to using polyoxyalkylene polyols in the hydroxyl number range from 25 to 40 mg KOH/g, which are preferably obtainable by reacting ethylene oxide and/or propylene oxide with trihydric polyols, for example glycerol, trimethylolpropane, or with dihydric polyols, for example ethylene glycol, water, 1,2-propylene glycol, neopentyl glycol, bisphenols inter alia.

As component B2) preference is given to using polyoxyalkylene polyols in the hydroxyl number range from 380 to 650 mg KOH/g, which are preferably obtainable by reacting ethylene oxide and/or propylene oxide with polyols, for example glycerol, trimethylolpropane, triethanolamine, ethylenediamine, ortho-tolyldiamine, mixtures of sugars and/or sorbitol with glycols inter alia.

As component B3) bifunctional polyoxyalkylene polyols in the hydroxyl number range from 150 to 550 are used, which are preferably obtainable by reacting ethylene oxide and/or propylene oxide with glycols, for example ethylene glycol, diethylene glycol, 1,2- or 1,3-propylene glycol, butane-1,4-diol, neopentyl glycol, bisphenols inter alia.

As component B4) polyols containing ester groups in the hydroxyl number range from 200 to 500 mg KOH/g are preferably employed, which can preferably be prepared by esterification of phthalic anhydride, terephthalic acid, isophthalic acid, glutaric acid, succinic acid and/or adipic acid with ethylene glycol, diethylene glycol, propylene glycol, butanediol, hexanediol, trimethylolpropane, glycerol inter alia. Particular preference is given to the use of a reaction product of phthalic anhydride, diethylene glycol and ethylene oxide.

As component B5) preference is given to using hexafunctional propylene oxide-ethylene oxide copolymers in the hydroxyl number range from 25 to 200, which are preferably obtainable by reaction of ethylene oxide and propylene oxide with sorbitol and its isomers. Particular preference is given to a proportion of ≥10% by weight of ethylene oxide units, based on (B5).

The catalysts (B8) include compounds that accelerate the reaction to produce the foam. Useful examples include organic metal compounds, preferably organic tin compounds, such as tin(III) salts of organic carboxylic acids, for example tin(II) acetate, tin(II) octoate, tin(II) ethylhexanoate, tin(II) laurate, and the dialkyltin(IV) salts of organic carboxylic acids, for example dibutyltin diacetate, dibutyltin dilaurate, dibutyltin maleate, dioctyltin diacetate, bismuth and zinc salts, and tertiary amines such as triethylamine, tributylamine, dimethylcyclohexylamine, dimethylbenzylamine, N-methylimidazole, —N-methyl-, —N-ethyl-, —N-cyclohexylmorpholine, —N,N,N′,N′-tetramethylethylenediamine, —N,N,N′,N′-tetramethylbutylendiamine, —N,N,N′,N′-tetramethylhexylene-1,6-diamine, pentamethyldiethylenetriamine, tetramethyl diaminoethyl ether, bis(dimethylaminopropyl)urea, dimethylpiperazine, 1,2-dimethylimidazole, 1-azabicyclo[3.3.0]octane, 1,4-diazabicyclo[2.2.2]octane, and alkanolamine compounds such as triethanolamine, trisisopropanolamine, —N-methyl- and —N-ethyldiethanolamine and dimethylethanolamine. Further useful catalysts include: tris(dialkylamino)-s-hexahydrotriazines, especially tris(N,N-dimethylamino)-s-hexahydrotriazine, tetraalkylammonium salts, for example N,N,N-trimethyl-N-(2-hydroxypropyl)ammonium formate, —N,N,N-trimethyl-N-(2-hydroxypropyl)ammonium 2-ethylhexanoate, tetraalkylammonium hydroxides such as tetramethylammonium hydroxide, alkali metal hydroxides such as sodium hydroxide, alkali metal alkoxides such as sodium methoxide and potassium isopropoxide, and alkali metal or alkaline earth metal salts of fatty acids having 1 to 20 carbon atoms and optionally lateral OH groups.

Preference is given to using tertiary amines that are reactive toward isocyanates, for example N,N-dimethylaminopropylamine, bis(dimethylaminopropyl)amine, —N,N-dimethylaminopropyl-N′-methylethanolamine, dimethylaminoethoxyethanol, bis(dimethylaminopropyl)amino-2-propanol, N,N-dimethylaminopropyldipropanolamine, N,N,N′-trimethyl-N′-hydroxyethylbisaminoethyl ether, N,N-dimethylaminopropylurea, N-(2-hydroxypropyl)imidazole, N-(2-hydroxyethyl)imidazole, N-(2-aminopropyl)imidazole, 2-((dimethylamino)ethyl)methylaminopropanol, 1,1′-((3-(dimethylamino)propyl)imino)bis-2-propanol and/or the reaction products, described in EP-A 0 629 607, of ethyl acetoacetate, polyether polyols and 1-(dimethylamino)-3-aminopropane and especially the tall oil acid amide salt of N,N-dimethylaminopropylamine.

As auxiliaries and/or additives B9) it is possible to use, for example, colorants, foam stabilizers, inorganic fillers, emulsifiers, cell openers and flame retardants.

Suitable foam stabilizers are, for example, siloxane-polyoxyalkylene copolymers, organopolysiloxanes, ethoxylated fatty alcohols and alkylphenols, fatty acid-based amine oxides and betaines, and castor oil esters or ricinoleic esters.

Examples of substances that act as cell openers include paraffins, polybutadienes, fatty alcohols and optionally polyalkylene oxide-modified dimethylpolysiloxanes.

Further examples of auxiliaries and/or additives B9) optionally to be used in accordance with the invention are emulsifiers, reaction retardants, stabilizers to counter aging and weathering effects, plasticizers, inorganic flame-retardant substances, phosphorus- or halogen-containing organic flame retardants, fungistatic and bacteriostatic substances, pigments and dyes and also customary organic and inorganic fillers known per se. Emulsifiers include, for example, ethoxylated alkylphenols, alkali metal salts of fatty acids, alkali metal salts of sulfated fatty acids, alkali metal salts of sulfonic acids and salts of fatty acids and amines.

Further details of the mode of use and mode of action of the aforementioned auxiliaries and/or additives are described for example in Kunststoff-Handbuch [Plastics Handbook], Polyurethanes, Vol VII, Carl Hanser Verlag, Munich, Vienna, 2nd edition, 1983.

The foam can be produced by mixing the polyol formulation with the polyisocyanate component, generally in the weight ratios of 100:150 to 100:200. This mixing is typically effected with a low-pressure foaming machine.

A specific example (example 1 from EP 2 784 100 A1) of a polyol component B) usable in accordance with the invention is a mixture comprising:
30.0 parts by weight of polyether alcohol (B1) based on glycerol/propylene oxide/ethylene oxide, OH number 28 mg KOH/g, functionality 3,
34.0 parts by weight of polyether alcohol (B2) based on trimethylolpropane/propylene oxide, OH number 550 mg KOH/g, functionality 3,
15.0 parts by weight of polyesterether alcohol (B4) based on phthalic anhydride/diethylene glycol/ethylene oxide, OH number 300 mg KOH/g, functionality 2,
12.0 parts by weight of polyether alcohol (B3) based on propylene glycol/propylene oxide, OH number 512 mg KOH/g, functionality 2,
0.50 part by weight of polyoxyalkylene polyols (B5) based on sorbitol/propylene oxide/ethylene oxide, OH number 100 mg KOH/g and a functionality of 6,
6.40 parts by weight of water (B7)
1.80 parts by weight of a reaction product, as described in EP 0629607 A2, of ethyl acetoacetate, polyether polyols and 1-(dimethylamino)-3-aminopropane, with a functionality of about 2-3 and an OH number of 111 mg KOH/g (B8)
0.30 part by weight of silicone foam stabilizer (Niax® Silicone SR 234 from Momentive Performance Materials) (B9),

This polyol component can be reacted, for example, (example 1 from EP 2 784 100 A1) with the following isocyanate component A):
182 parts by weight of a technical grade isocyanate having a proportion of about 14% by weight, based on organic polyisocyanate component A), of diphenylmethane 2,4′-diisocyanate and of about 45% by weight, based on organic polyisocyanate component A), of diphenylmethane 4,4′-diisocyanate, and an NCO content of 31.8% by weight.

As documented in example 1 from EP 2 784 100 A1, foam blocks produced therefrom may have the following average properties: apparent density (DIN 53420) 23.0 kg/m³; compressive strength (10% compression, DIN EN 826) 98 kPa and elongation at break (DIN 53430) 19%.

A further specific example (example 2 from EP 2 784 100 A1) of a polyol component B) usable in accordance with the invention is a mixture comprising:
30.0 parts by weight of polyether alcohol (B1) based on glycerol/propylene oxide/ethylene oxide, OH number 28 mg KOH/g, functionality 3,
34.2 parts by weight of polyether alcohol (B2) based on trimethylolpropane/propylene oxide, OH number 550 mg KOH/g, functionality 3,
15.0 parts by weight of polyesterether alcohol (B4) based on phthalic anhydride/diethylene glycol/ethylene oxide, OH number 310 mg KOH/g, functionality 2,
12.0 parts by weight of polyether alcohol (B3) based on propylene glycol/propylene oxide. OH number 512 mg KOH/g, functionality 2,
0.30 part by weight of polyoxyalkylene polyols (B5) based on sorbitol/propylene oxide/ethylene oxide, OH number 100 mg KOH/g, functionality of 6,
1.9 parts by weight of reaction product of ethyl acetoacetate, a polyether alcohol based on trimethylolpropane/propylene oxide (OH number 550 mg KOH/g) and 1-(dimethylamino)-3-aminopropane analogously to EP 0 629 607 (B8)
0.30 part by weight of silicone foam stabilizer (Niax® Silicone SR 234 from Momentive Performance Materials) (B9).
5.8 parts by weight of water (B7)

This polyol component can be reacted, for example, (example 2 from EP 2 784 100 A1) with the following isocyanate component A):
172 parts by weight of a technical grade isocyanate having a proportion of about 21% by weight, based on organic polyisocyanate component A), of diphenylmethane 2,4′-diisocyanate and of about 44% by weight, based on organic polyisocyanate A), of diphenylmethane 4,4′-diisocyanate, and an NCO content of about 31.9% by weight.

As documented in example 1 from EP 2 784 100 A, foam blocks produced therefrom may have the following average properties: apparent density (DIN 53420) 24.2 kg/m³; compressive strength (10% compression, DIN EN 826) 97 kPa and elongation at break (DIN 53430) 19.83%.

In a further preferred embodiment, the polyol component comprises a blowing agent which is a mixture of water and at least one physical blowing agent.

In a further preferred embodiment, the reaction mixture is provided in the volume without interruption. The introduction without interruption could thus be characterized as a “one-shot” process.

In a further preferred embodiment, the shell produced by the additive manufacturing method encompasses the volume in partly interrupted form. For instance, the shell may have an opening for the introduction of the reaction mixture, where this opening has an area (based on the total surface area of the additively manufactured shell) of ≤10%, preferably ≤5% and more preferably ≤3%.

In a further preferred embodiment, the shell produced by the additive manufacturing method encompasses the volume in uninterrupted form. The shell is thus a completely closed shell. The reaction mixture can be introduced through the shell by injection by means of an injection cannula.

In a further preferred embodiment, the shell produced in the additive manufacturing methods comprises one or more sections that can be opened temporarily and are set up to release the positive gas pressure built up in the volume. Such sections may take the form of valves, the integration of which into the shell should not present any difficulties in view of the fact that the shell has been produced by an additive manufacturing method. What are called duckbill valves are particularly suitable. Such openable sections can contribute to the effect that, during the foaming of the reaction mixture with release of gaseous blowing agent, the internal pressure in closed volumes does not rise to such a degree that the shell bursts open. In the course of aftertreatment, these sections can also be mechanically removed after production of the article.

The invention further relates to an article obtainable by a method of the invention, comprising a shell that defines a volume within the shell and a foam that wholly or partly fills the volume, wherein the shell comprises a thermoplastic polyurethane polymer, the foam comprises a polyurethane foam having a compressive strength at 10% compression (DIN EN 826) of ≥50 kPa, preferably ≥95 kPa to ≤800 kPa, or a compression hardness at 40% compression (ISO 3386-1) of ≤15 kPa, preferably ≤12 kPa, most preferably ≥1 kPa to ≤10 kPa, and the foam and the shell are at least partly cohesively bonded to one another.

The volume filled may, for example, be ≥1 cm³ to ≤5000 cm³.

In a preferred embodiment of the article, the shell comprises temporarily openable sections set up to release positive gas pressure built up within the volume. Such sections may take the form of valves, the integration of which into the shell should not present any difficulties in view of the fact that the shell has been produced by an additive manufacturing method. What are called duckbill valves are particularly suitable. Such openable sections can contribute to the effect that, during the foaming of the reaction mixture with release of gaseous blowing agent, the internal pressure in closed volumes does not rise to such a degree that the shell bursts open. In the course of aftertreatment, these sections can also be mechanically removed after production of the article.

In a further preferred embodiment of the article, the shell comprises elements that project into the volume. In this way, it is possible to achieve structural reinforcement of the article.

In a further preferred embodiment of the article, the article is a ball. The ball is preferably used as a toy or as sports equipment, for example as a football, basketball, handball, tennis ball, rounders ball or the like Such a ball may also have elements projecting from the shell into the volume. The ball preferably has a closed shell and, as filling, a foam having an apparent density (ISO 845) of ≤100 g/L and a compressive strength at 10% compression (DIN EN 826) of ≥50 kPa. In that case, the foam should be regarded as a rigid elastic foam.

### DESCRIPTION OF THE FIGURES

FIG. 1 shows a view from below of the 3D-printed shell (4) of an inventive article (10) according to example 1, composed of three intermeshing elements (2, 2′, 2″) with walls (1) and the polymer-filled volume (3, 3′, 3″) enclosed thereby.

FIG. 2 shows a side view of the mold from example 1, composed of three intermeshing elements (2, 2′, 2″).

FIG. 3 shows a top view of the mold from example 1, composed of three intermeshing elements (2, 2′, 2″).

### EXAMPLES

### Inventive Example 1

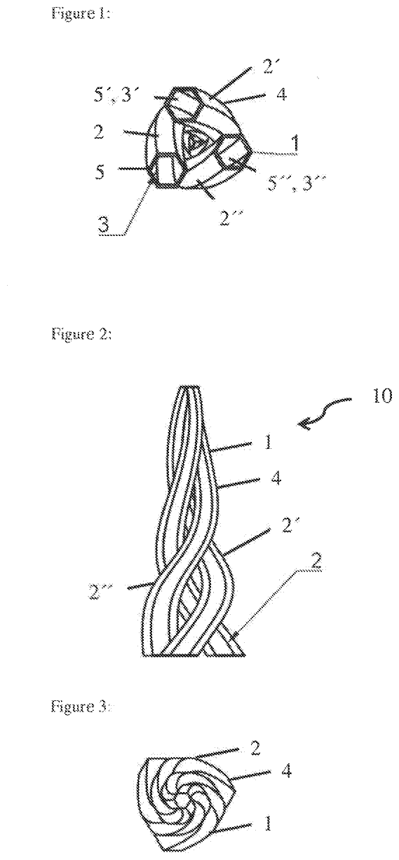

An inventive article 10 was produced by first additively manufacturing a shell 4 and then filling it with a reaction mixture. The shell 4 was produced by the SLA method. The UV-reactive resin used was the Greay FLGPGR03 photopolymer resin from Formlabs and was processed in the Form 2 SLA printer from the manufacturer Formlabs. The shell forms a mold composed of three intermeshing, hollow elements (2, 2′, 2″) having a wall thickness of 2 mm. The elements (2, 2′, 2″) were open at the bottom in order to enable the filling with polymer, as shown in FIG. 1. After printing and removing adhering liquid photopolymer, a reaction mixture was introduced into this shell in order to obtain an article 10 as shown in FIG. 2. FIG. 3 shows a top view of the inventive article 10. However, the articles 10 shown in FIGS. 1 to 3 are merely illustrative and may have any shape achieved by 3D printing.

As reaction mixture for the polymer for filling of the hollow elements (2, 2′, 2″) was firstly a prepolymer of 51% by weight of methylene diphenyl isocyanate, 29% by weight of trifunctional polypropylene polyether polyol having a hydroxyl number of 35, 18% by weight of a linear polypropylene polyether polyol having a hydroxyl number of 28, 1% by weight of para-toluenesulfonyl isocyanate, 0.6% by weight of a polyether-modified polysiloxane as foam stabilizer (Tegostab B 1903, sourced from Evonik industries AG) and 0.4% by weight of dibutyltin dilaurate as catalyst. 25 g of this prepolymer were mixed with 2.5 g of water as chemical blowing agent to give a prepolymer mixture and stirred rapidly with a wooden spatula within 2 to 3 minutes. Immediately thereafter, the prepolymer mixture was poured into the additively manufactured shell 4 in order to obtain the article 10 as shown in FIGS. 2 and 3. The prepolymer mixture has a drying time of 3 h, ascertained in a moisture curing system at 23° C. and 50% relative humidity.

After 24 h, the excess foam at the openings 5, 5′, 5″ was removed with a sharp knife. Thus, an inventive article 10 is obtained from an additively manufactured shell 4 filled completely with a polymer foam. The shell 4 and the cured polymer are bonded to one another in such a way which has little stress between the shell 4 and the volume 3, 3′, 3″ that encloses the shell 4 formed from the walls 1. Owing to this exact form-fitting, the article 10 has high stability. The shell 4 and the polymer are firmly bonded to one another, such that they preferably cannot be separated from one another again without destruction of the article 10. In this way, it is possible to very rapidly produce geometrically complex and simultaneously voluminous structures that would not be producible without 3D printing. At the same time, production of the complete article by a 3D printing method would be extremely time-consuming. There is additionally high flexibility in the selection and combination of the properties of the materials of the shell and of the polymer, which enables inexpensive production of a wide variety of different geometries in combination with a wide variety of different material properties.

1. A method of producing an article (10), comprising the steps of:
producing a shell (4) encompassing a volume (3, 3′, 3′) for accommodating a fluid by means of an additive manufacturing method from a construction material;
providing a reaction mixture comprising a polyisocyanate component and a polyol component in the volume (3, 3′, 3″);
allowing the reaction mixture to react in the volume (3, 3′, 3′) to obtain a polymer present at least in part in the volume (3, 3′, 3′),
characterized in that
the reaction mixture has a setting time of ≥2 minutes.

2. The method as claimed in claim 1, characterized in that the construction material is free-radically crosslinkable and comprises groups having Zerewitinoff-active hydrogen atoms, in that the shell (4) is obtained from a precursor, and in that the process comprises the steps of:
I) depositing free-radically crosslinked construction material on a carrier to obtain a ply of a construction material bonded to the carrier which corresponds to a first selected cross section of the precursor;
II) depositing free-radically crosslinked construction material onto a previously applied ply of the construction material to obtain a further ply of the construction material which corresponds to a further selected cross section of the precursor and which is bonded to the previously applied ply;
III) repeating step II) until the precursor is formed;
wherein the depositing of free-radically crosslinked construction material at least in step II) is effected by exposure and/or irradiation of a selected region of a free-radically crosslinkable construction material corresponding to the respectively selected cross section of the precursor, and
wherein the free-radically crosslinkable construction material has a viscosity (23° C., DIN EN ISO 2884-1) of ≥5 mPas to ≤100 000 mPas,
wherein the free-radically crosslinkable construction material comprises a curable component in which there are NCO groups and olefinic C═C double bonds,
and in that step III) is followed by a further step IV):
IV) heating the precursor obtained by step III) to a temperature of ≥50° C. to obtain the shell (4).

3. The method as claimed in claim 2, characterized in that
the carrier is disposed within a vessel and is lowerable vertically in the direction of gravity,
the vessel contains the free-radically crosslinkable construction material in an amount sufficient to cover at least the carrier and an uppermost surface of crosslinked construction material deposited on the carrier as viewed in vertical direction,
before each step II) the carrier is lowered by a predetermined distance so that a layer of the free-radically crosslinkable construction material is formed above the uppermost ply of the crosslinked construction material as viewed in vertical direction and
in step II) an energy beam exposes and/or irradiates the selected region of the layer of the free-radically crosslinkable construction material corresponding to the respectively selected cross section of the precursor.

4. The method as claimed in claim 2, characterized in that
the carrier is disposed within a vessel and is liftable vertically counter to the direction of gravity,
the vessel provides the free-radically crosslinkable construction material,
before each step II) the carrier is lifted by a predetermined distance so that a layer of the free-radically crosslinkable construction material is formed below the lowermost ply of the crosslinked construction material as viewed in vertical direction and
in step II) a multitude of energy beams simultaneously expose and/or irradiate the selected region of the layer of the free-radically crosslinkable construction material corresponding to the respectively selected cross section of the precursor.

5. The method as claimed in claim 2, characterized in that
in step II) the free-radically crosslinkable construction material is applied from one or more print heads corresponding to the respectively selected cross section of the precursor and is subsequently exposed and/or irradiated.

6. The method as claimed in claim 1, characterized in that the production of the shell (4) by means of the additive manufacturing method comprises the steps of:
applying a layer of particles including the construction material to a target surface;
introducing energy into a selected portion of the layer corresponding to a cross section of the shell (4) to bond the particles in the selected portion;
repeating the steps of applying and introducing energy for a multitude of layers to bond the bonded portions of the adjacent layers to form the shell (4).

7. The method as claimed in claim 1, characterized in that the production of the shell (4) by means of the additive manufacturing method comprises the steps of:
applying a layer of particles including the construction material to a target surface;
applying a liquid to a selected portion of the layer corresponding to a cross section of the shell (4), where the liquid is selected in such a way that it bonds the particles to one another in the regions of the layer with which it comes into contact by bonding, fusion and/or partial dissolution;
repeating the steps of applying the layer and the liquid to bond the bonded portions of the adjacent layers to form the shell (4).

8. The method as claimed in claim 1, characterized in that the production of the shell (4) by means of the additive manufacturing method comprises the steps of:
applying a filament of an at least partly molten construction material to a carrier to obtain a ply of the construction material corresponding to a first selected cross section of the shell (4);
applying a filament of the at least partly molten construction material to a previously applied ply of the construction material to obtain a further ply of the construction material which corresponds to a further selected cross section of the shell (4) and which is bonded to the ply applied beforehand;
repeating the step of applying a filament of the at least partly molten construction material to a previously applied ply of the construction material until the shell (4) has been formed.

9. The method as claimed in claim 1, characterized in that the reaction mixture reacts to form a foam having a compressive strength at 10% compression (DIN EN 826) of ≥50 kPa or to form a foam having a compression hardness at 40% compression (ISO 3386-1) of ≤15 kPa.

10. The method as claimed in claim 1, characterized in that the polyol component comprises a bifunctional polyether polyol and/or a bifunctional polyester polyol and/or a bifunctional polyether carbonate polyol.

11. The method as claimed in claim 1, characterized in that the polyol component comprises a blowing agent which is a mixture of water and at least one physical blowing agent.

12. The method as claimed in claim 1, characterized in that the reaction mixture is provided in the volume (3, 3′, 3′) in an uninterrupted manner.

13. An article (10) obtainable by a method as claimed in claim 1, comprising a shell (4) that defines a volume (3, 3′, 3′) within the shell (4) and a foam that wholly or partly fills the volume (3, 3′, 3′),
characterized in that
the shell (4) comprises a thermoplastic polyurethane polymer, the foam comprises a polyurethane foam having a compressive strength at 10% compression (DIN EN 826) of ≥50 kPa or a compression hardness at 40% compression (ISO 3386-1) of ≤15 kPa, and the foam and the shell (4) are at least partly cohesively bonded to one another.

14. The article (10) as claimed in claim 13, characterized in that the shell (4) comprises elements that project into the volume (3, 3′, 3′″).

15. The article (10) as claimed in claim 13, characterized in that the article (10) is a ball.
